(19) United States
(12) Patent Application Publication
(10) Pub. No.: US 2008/0304702 A1
(43) Pub. Date: Dec. 11, 2008

(54) Blind Detection for Digital Cinema

(75) Inventor: Adriaan Johan Van Leest, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/158,700

(22) PCT Filed: Dec. 20, 2006
(86) PCT No.: PCT/IB06/54973

§ 371 Date: Jun. 23, 2008

(30) Foreign Application Priority Data
Dec. 23, 2005 (EP) 05112879.1

(51) Int. Cl. G06K 9/36

(52) U.S. Cl. 382/100

(57) ABSTRACT

The invention relates to embedding in, as well as to extracting a payload from a motion image signal. Furthermore, the invention relates to a motion image signal. A payload is embedded in the motion image signal by the following steps. A first and an at least second watermark are represented by at least a first sequence of watermark samples, and a first and at least a second global property of an image of the signal are determined. Subsequently, the first and the at least second watermark are embedded in the signal, so that a shift of the at least second watermark with respect to the first watermark represents the payload. The first and the at least second watermarks are embedded by modifying the first and the at least second global property in the image in accordance with the corresponding watermark samples. The first and second global properties may be the mean luminance and the mean color saturation of the pixels constituting the image.

### FIELD OF THE INVENTION

The invention relates to a method of embedding and to a method of extracting a payload in a motion image signal. The invention also relates to a watermark embedder, a watermark detector, a motion image signal, a storage medium and to computer readable code.

### BACKGROUND OF THE INVENTION

Watermark embedding is an important aspect of copy protection strategies. Although most copy protection schemes deal with protection of electronically distributed contents (broadcast, storage media), copy protection is also desired for movies being shown in theatres. Illegal copying in the cinema by means of a handheld video camera is already common practice. The quality is usually very low, but the economical impact of illegal VHS tapes, CD-videos and DVD's can be enormous.

The video watermarking scheme for the Digital Cinema project is designed to work with the upcoming digital cinema format and to assist content owners and distributors with tracing the origin of the illegal copies. The watermark is designed such that it has minimal impact on the video quality, but still is detectable after capture with a handheld camera and conversion to, for instance, VHS, CD-video or DVD format. This requirement for the watermark to survive a camera recording implies that the watermark should survive geometrical distortions like zooming, rotation and movement. In order to meet the severe visibility and robustness requirements, the watermarking system only exploits the temporal axis. In the watermarking scheme for the Digital Cinema project, a watermark is inserted by changing the mean of the luminance values of a frame according to the samples of the watermark.

International patent application WO/03001813 A1 discloses a method comprising the steps of determining a global property of the pixels constituting an image of a signal, where the global property is modified in accordance with a watermark sample. In an embodiment, the global property is the mean luminance of an image.

The requirements for digital cinema and any other watermarking schemes include robustness, imperceptibility and a low false positive rate.

### SUMMARY OF THE INVENTION

The inventor of the present invention has appreciated that for watermark schemes of the prior art, it may be problematic to fulfill the above requirements in conjunction with embedding a multibit payload in a digital signal; and the inventor has in consequence devised the present invention. In addition, the present invention seeks to provide an improved means for copyright protection, and preferably, the invention alleviates, mitigates or eliminates one or more disadvantages of the prior art, singly or in any combination.

According to a first aspect of the present invention there is provided, a method of embedding a payload in a motion image signal, the method comprising:

representing a first and an at least second watermark by at least a first sequence of watermark samples;

determining a first and at least a second global property of an image of the signal;

embedding the first and the at least second watermark in the signal, so that a shift of the at least second watermark with respect to the first watermark represents a payload;

wherein the first and the at least second watermarks are embedded by modifying the first and the at least second global property in the image in accordance with the corresponding watermark samples.

The sequence(s) of watermark samples constituting the first and at least second watermark is distributed over a sequence of images of the image signal, where one or more watermark samples being embedded per image. The method thus embeds the watermarks along the temporal axis and is therefore inherently robust against all geometrical distortions.

The first watermark may represent a reference watermark, whereas the at least second watermark may represent a shifted watermark (or vice versa). The shift may be a cyclically rotation of the watermark along the temporal axis.

For a digital watermark, due to imperceptibility constraints, the watermark energy is very low compared to the energy of the image signal this may render detection of a watermark uncertain. By embedding a first and at least a second watermarks by modifying the first and the at least second global property of an image, both watermarks may be embedded with a similar energy as if only one watermark was embedded. This is particularly but not exclusively advantageous since by being able to embed two watermarks, both a reference watermark and a shifted watermark may be embedded, thereby enabling blind detection of an embedded payload. By being able to perform blind detection, the complex task of time-synchronization with the original movie can be avoided in order to extract the payload.

The optional features as defined in claims 2 and 3 are advantageous since by using different color component of the image signal, and more specifically using the mean luminance and the mean color saturation of the pixels constituting the image, signal components are used in which the watermark samples may be both embedded and detected in a robust and secure way.

The optional features as defined in claim 4 are advantageous since by dividing an image of the image signal into at least two image areas, and embedding either different or same watermarks in the different image areas, embodiments may be provided where de-flickering tools does not remove the watermarks as well as the payload may be increased.

Claim 5 describes an advantageous embodiment of providing watermark samples.

The optional features as defined in claims 6 and 7 are advantageous since by adaptively modifying the pixels of the image or image area upon a spatial activity or upon motion, the embedding strength of the watermark sample may adaptively be adjusted, thereby embedding a watermark which for a given situation provides an optimized compromise between imperceptibility and a low false positive rate.

The optional features as defined in claim 8 are advantageous since the flicker frequency of the watermark samples may be lowered, thereby reducing or even removing visual artifacts from the watermarks samples.

The optional features as defined in claims 9 and 10 are advantageous since embodiment which are robust to de-flickering operations are provided.

According to a second aspect of the present invention there is provided a method of extracting a payload from a motion image signal, the method comprising:

receiving an image signal including a first watermark and at least a second watermark, the first and the at least second watermarks being representing by at least a first sequence of watermark samples;

providing the first and at least second watermarks to be detected in the image signal;

determining a first and at least a second global property of an image of the signal in the signal;

extracting the first watermark by comparing a sequence of first global properties with the first watermark to be detected;

extracting the at least second watermark by comparing a sequence of at least second global properties with the at least second watermark to be detected;

comparing the first and the at least second watermark so as to determine a shift of the at least second watermark with respect to the first watermark;

extracting from the shift a payload.

The invention according to the second aspect is particularly but not exclusively advantageous since it facilitates extracting a payload from a motion image signal, such as a payload being embedded by the method according to the first aspect of the invention.

According to a third and fourth aspect of the present invention there are provided a watermark embedder comprising:

signal unit for receiving a motion image signal;

watermark sample unit for representing a first and an at least second watermark by at least a first sequence of watermark samples;

global property unit for determining a first and at least a second global property of an image of the signal;

embedding unit for embedding the first and the at least second watermark in the signal, so that a shift of the at least second watermark with respect to the first watermark represents a payload;

wherein the first and the at least second watermarks are embedded in the embedding unit by modifying the first and the at least second global property in the image in accordance with the corresponding watermark samples and a watermark detector comprising:

signal unit for receiving a motion image signal, the image signal including a first watermark and at least a second watermark, the first and the at least second watermarks being representing by at least a first sequence of watermark samples;

watermark unit for providing the first and at least second watermarks to be detected in the image signal;

global property unit for determining a first and at least a at least second global property of an image of the signal;

extractor unit for extracting the first watermark by comparing a sequence of first global properties with the first watermark to be detected, and for extracting the at least second watermark by comparing a sequence of at least second global properties with the at least second watermark to be detected;

comparator unit for comparing the first and the at least second watermark so as to determined a shift of the at least second watermark with respect to the first watermark;

payload unit for extracting from the shift a payload.

Some or all of the units of the third and fourth aspects of the invention may be implemented as combined units or separated units.

The watermark embedded of the third aspect of the invention is provided in accordance with the method of the first aspect of the invention, and the method of the first aspect of the invention may be implemented for controlling a watermark embedder of the third aspect of the invention. The watermark detector of the fourth aspect is provided in accordance with the second aspect of the invention, and the method of the second aspect may be implemented for controlling a watermark detector of the fourth aspect of the invention.

In a fifth aspect of the invention is provided a motion image signal with a first and an at least second embedded watermark, the watermarks being represented by at least a first sequence of watermark samples, for an image of the signal a first and at least a second global property of the image have been modified in accordance with a respective watermark sample of the corresponding watermark samples.

In a sixth and seventh aspects of the invention are provided computer readable code for implementing the methods of the first and second aspects.

In general the various aspects of the invention may be combined and coupled in any way possible within the scope of the invention.

These and other aspects, features and/or advantages of the invention will be apparent from and elucidated with reference to the embodiments described hereinafter.

### BRIEF DESCRIPTION OF THE DRAWINGS

Embodiments of the invention will be described, by way of example only, with reference to the drawings, in which

FIG. 1. illustrates a schematic diagram of a watermark embedder in accordance with an embodiment the invention;

FIG. 2 illustrates an embodiment where the image of the image signal is divided into at least four image areas.

FIG. 3 illustrates a schematic diagram of a watermark detector in accordance with an embodiment the invention.

### DESCRIPTION OF EMBODIMENTS

In an embodiment of the invention, the embedding aspects are applied in connection with projecting digital movies in a movie theatre. In an embodiment, the digital movie projector either includes or is connected to a watermark embedder in accordance with the present invention, and during projection of the movie the watermarks are embedded. Typically such information as serial number of the projector and a time code are embedded as the payload.

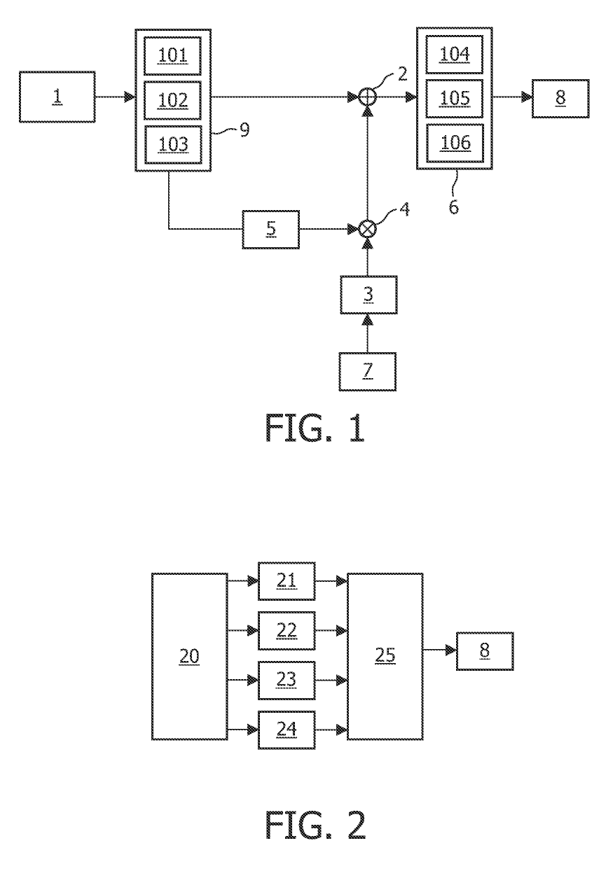

FIG. 1. illustrates an embodiment of a schematic diagram of a watermark embedding scheme, i.e. FIG. 1 illustrates a watermark embedder in accordance with the present invention. The embedding scheme facilitates embedding a payload in a motion image signal comprising a sequence of images or frames. The payload is typically in the form of a multi-bit payload. The payload is embedded in the image signal by embedding a reference watermark and a shifted watermark, the shift being indicative of the payload. The shift may be a cyclic rotation of the watermark along the temporal axis. The reference watermark (or first watermark) and the shifted watermark (or second watermark) being embedded by modifying a first and an at least second global property in the image in accordance with a corresponding watermark sample.

In an embodiment is the watermark embedding performed in the (Y, U, V) color representation of the signal; Y referring to the luminance component and U and V referring to the chrominance components, the image signal being referred to as X(Y, U, V).

The embedder receives the image signal X(Y, U, V) at a signal unit 1, the image signal being a sequence of images or frames having a first global property being the luminance F(n,k) 101 and second global properties being the chrominance values G_{U}(n,k) 102 for the U-component and G_{V}(n,k) 103 for the V-component at a spatial position n of frame k. In principle the chrominance values U, V may be viewed upon as two global properties, however here they are dealt with and referred to as a single (second) global property, namely as the mean color saturation. The global properties being determined at a global property unit 9. The embedder further receives a sequence of watermark samples at a watermark sample unit 7 representing the watermark in the form of a pseudo-random sequence w(n) of length L, where w(n)e [−1,1], i.e. each watermark sample being a first or a second value. An appropriate value of L is 1024, however other values of L may be used. The watermarks may repeat themselves every L frames. In an embodiment is the same sequence of watermark samples applied for both the reference and the shifted watermark, nevertheless the sequence of watermark samples may be different for the two watermarks.

In an embodiment of the watermark embedder, the sequence w(n) is directly applied to the received signal by an embedding unit 2. Since the Human Visual System (HVS) is sensitive to flicker in low spatial frequencies, such embodiment may suffer from artifacts in especially non-moving flat areas. These artifacts are significantly reduced by lowering the flicker frequency of the watermark. This is performed by a repetition stage 3, which repeats each watermark sample during a predetermined number K of consecutive images. The same watermark sample is thus embedded in a series of K consecutive frames or images, K may be in the order of 5, but other values of K may be applied. The watermark sample w(n) being embedded in frame k can mathematically be denoted by w([k/K] mod N). For simplicity, this expression is hereinafter abbreviated to w(k).

The embodiment of the embedder as shown in FIG. 1 further adapts the embedding depth in dependence upon the image contents by adaptively modifying the pixels of the image upon a spatial activity within the image or upon motion detected between consecutive images. In an embodiment, may areas where there is enough activity to embed the watermark be obtained by filtering the chrominance values with a high-pass filter. Alternatively, also the result of the high-pass filtered luminance values could be used to obtain the corresponding chrominance values to embed the watermark. Similarly also the motion detection intended for the luminance values could be used to obtain the values also for the chrominance values. It may be beneficial to use luminance values since these may be less complicated to obtain and it reduces the complexity of the embedder. The adaptive modifying being conducted by multiplying the watermark sample w(k) with one or more local scaling factors, the multiplication being done by a multiplier 4. A single scaling factor C_{FG}(n,k) may be used for both luminance and chrominance color components, however different scaling factors may also be applied for the luminance C_{F}(n,k) and chrominance C_{G}(n,k) components. The one or more local scaling factors are derived from the image contents by image analyser 5. For example, a scaling factor is large in moving textured parts of an area and small in non-moving flat parts.

The output of the embedding unit 2 can be formulated as:

F_{w}(n,k)=F(n,k)+C_{F}(n,k)w(k)

G_{U,w}(n,k)=H(G_{U}(n,k),w(k))

G_{V,w}(n,k)=H(G_{V}(n,k),w(k))

where H is a function depending on chrominance value G_{U}(n,k) or G_{V}v(n, k) and the watermark sample w(k). The luminance part Fw_{w}(n,k) 104 and the chrominance parts G_{U,w}(n,k) 105, G_{V,w}(n,k) 106 are subsequently combined at a combining stage 6 into a single watermarked image I_{w}(n,k) 8.

At the embedder stage or unit 2, two watermarks are embedded in the image signal. The first watermarks is embedded by increasing the luminance of individual pixels of frame n if the watermark sample w(n)=+1, and decreasing it if w(n)=−1. The luminance of a pixel is only modified for pixels which are allowed to be modified. This depends on the spatial activity and motion as described above. Thus not all pixels are modified in practice, but only a part. The mean luminance of the sequence of frames is thus modulated by the watermark sample w(n).

The second watermark is embedded by changing the mean saturation of the colors. The mean saturation of a color is modified by multiplying the chrominance U- and V-component of a pixel by the same factor. For example a pixel where the U- and V-component are 64 and 163 respectively (U- and V-components lie in the range of 0 . . . 255 in the case of 8 bits). Then the modified U-component Uₘ and modified V-component Vₘ are computed in the following way:

Uₘ=c(U−128)+128=c(6−128)+128=128−64c

Vₘ=c(V−128)+128=c(163−128)+128=35c+128

c is typically chosen to be close to 1. Firstly, a constant 128 is subtracted, since the chrominance values are centered around this value 128 by definition. When all chrominance values in a frame have (before subtraction) the value 128, then this frame is a grey level only image. Thus for the above example:

H=(1+w(k)*d)*(G_{U,V}(n,k)−128)+128

where d is a positive number close to 0 (e.g. 0.1), and where c=(1+w(k)*d).

If c>1, the mean saturation is increased, and if c<1 then the mean saturation of the color is decreased. Thus, when the watermark sample w(n)=1, c>1 is taken, and if the watermark sample w(n)=−1, c<1 is taken. For a negative chrominance value, the value becomes smaller when the saturation increases, i.e. when a watermark sample w(n)=1 is embedded. This fact has consequences for the detector (see below). Both the U- and V-chrominance values has to be modified simultaneously and with the same factor c to change the saturation of the color, otherwise a different color results, which in general will be visible. The energy of the watermark can be increased by increasing or decreasing c more and more from the neutral value c=1.

Other examples of global image properties that can be modulated by the watermark samples are picture histograms (a list of relative frequencies of luminance and chrominance values in the image), or features derived there from such as high-order moments (average or luminance and chrominance values to a power k). The means luminance and mean color saturation are specific examples of the latter (k=1).

In other embodiments of the invention, an image of the image signal is divided into at least two image areas, the first and/or at least second watermark being embedded in an image area of the image by modifying the first and/or the at least second global properties of the image area. In this way, one or more watermarks or one or more versions of the same watermark may be embedded in the same or in different image areas. The different areas may be halves, quarters, etc. of the image.

FIG. 2 illustrates an embodiment where the image of the image signal is divided into four image areas at a divider stage 20. In an embodiment, the luminance component 101 is embedded into two image areas, and the chrominance components 102, 103 are embedded into other two image areas.

In this embodiment, the first embedding stage 21 adds with a certain scaling one applied watermark sample w(n) to the pixels of the first image area which are allowed to be modified resulting in a modified first global property (mean luminance) of the first area and the second embedding stage 22 adds with a certain scaling the opposite watermark sample −w(n) from the pixels of the second image area which are allowed to be modified also resulting in a modified first global property of the second area. The mean luminance of the first and second image areas are thus oppositely modulated by the watermark by the first and the second embedding stages. More specifically, the image is modified by the first and second embedding stages 21, 22 by increasing the first global property of the first area and decreasing the first global property of the second area for embedding the first value of the watermark sample into the image, and by decreasing the first global property of the first area and increasing the first global property of the second area for embedding the second value of the watermark sample into the image.

The third embedding stage 23 adds one applied watermark sample w(n) to the third image area by modifying second global property (mean color saturation) of the third area and the fourth embedding stage 24 adds the opposite watermark sample −w(n) by modifying the second global property. The mean color saturation of the third and fourth image areas are thus oppositely modulated by the watermark by the third and fourth embedding stages. More specifically, the image is modified by the third and fourth embedding stage 23, 24 by increasing the second global property of the third area and decreasing the second global property of the at least fourth area for embedding the first value of the watermark sample into the image, and by decreasing the second global property of the third area and increasing the second global property of the at least fourth area for embedding the second value of the watermark sample into the image.

The four image areas are subsequently combined by a combining stage 25 into a single watermarked image I_{w}(n,k) 8.

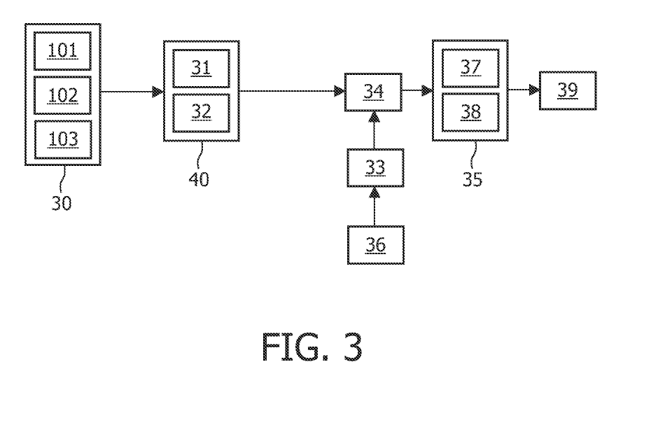

FIG. 3 shows a schematic diagram of a watermark detector in accordance with an embodiment the invention. Since both the reference watermark and the shifted watermark are present in the signal, the original signal is not needed for detection, i.e. blind detection is performed. The detector receives at a signal unit 30 an image signal including a first watermark and at least a second watermark in the form of a watermarked sequence of image or frames having a luminance F(n,k) 101 and chrominance values G_{U}(n,k) 102 for the U-component and G_{V}(n,k) 103 for the V-component at a spatial position n of frame k. The embedder furthermore receives (or knows) at a watermark unit 36 the watermark w to be detected. The detector further includes a global property unit 40 comprising a mean luminance computing circuit 31 and a mean chrominance computing circuit 32 which determines or computes the mean luminance and the mean chrominance, respectively (or other global property or properties, if applicable). The mean luminance being computed in accordance with:

$${f}_{w} ( k ) = \frac{1}{N} {\sum }_{\underline{n}} {F}_{w} ( \underline{n} , k )$$

and the mean chrominance being computed in accordance with:

$${S}_{U} ( k ) = \frac{1}{N} {\sum }_{n = 0}^{N - 1} \vert {U}_{k , m} ( n ) - 128 \vert and {S}_{V} ( k ) = \frac{1}{N} {\sum }_{n = 0}^{N - 1} \vert {V}_{k , m} ( n ) - 128 \vert$$

where N is the number of pixels in an image, and m reflects the modified chrominance values. In contrast to the mean luminance, in order to detect saturation changes, the chrominance values in a frame are not simply accumulated. As mentioned previously, an increase of saturation results in an increase of the absolute values of the chrominance values centered around a value of 128, while a decrease results in the opposite. Therefore, for each frame, a ‘mean saturation’ is obtained by first subtracting a value 128 and taking the absolute value of this result before accumulation.

The watermark can in one embodiment be detected by detecting the mean saturation S_{U} or S_{V} separately, and in another embodiment, the watermark is detected in the combined S_{U}+S_{V} sequence.

The first and second watermark are extracted at an extractor unit 34, here in the embodiment of a correlation unit or stage, by comparing a sequence of global properties with the respective watermark to be detected, or more specifically the watermark detector generates a sequence of estimated watermark samples for the mean chrominance and for the mean luminance. In the extractor unit 34, the sequence of estimated watermark samples is cyclically correlated with the watermark being looked for. In this embodiment, the comparison between a sequence of global properties and the respective watermark to be detected is a cyclic correlation. The detector receives this watermark being looked for, i.e. the watermark to be detected, in the form of a pseudo random sequence w(n) of length L, where w(n)ε[−1,1]. The detector comprises a repetition stage 33 which is identical to the repetition stage of the embedder. An embodiment of a correlation stage is described in EP 1 588 556 which is hereby incorporated by reference. The correlation may be performed using Symmetrical Phase Only Matched Filtering (SPOMF). For a description of SPOMF, reference is made to International Patent Application WO 99/45706, which is hereby incorporated by reference. The result of the SPOMF operation is a pattern of correlation values exhibiting one or more peaks if a watermark has been embedded.

In a next step in a comparator unit 35, the watermark found in the chrominance values 37 is compared with the watermark found in the luminance 38 so as to determine a shift between the two watermarks, the payload is extracted in a payload unit 39 from the determined shift.

In embodiments where the watermark sample is embedded into two or more areas of the image signal, such as for the embodiment described in connection with FIG. 2, the watermark detector comprises a dividing stage dividing the image into the relevant number of image areas, and detection stages for detecting the relevant watermark sample for the given image areas. An embodiment of a watermark detector with a dividing stage and individual detection stages for detecting the relevant watermark sample for the given image areas is described in EP 1 588 556.

In another embodiment, the payload may be increased by dividing an image of the image signal into four areas, two image areas for embedding a watermark in the luminance values, and two image areas for embedding a watermark in the chrominance values. In the first area of the luminance values w=w0+w1 is embedded and in the second area −w, where w is the sum of a reference watermark w0 and a shifted version w1. In the first area of the chrominance values z=z0+z1 is embedded and in the second area −z is embedded, where both z0 and z1 is a shifted version of w0. Because of this addition and a certain amount of total allowable watermark energy, the detection peaks will decrease. Nevertheless, there can be applications where robustness is of less concern. The watermarks w0+w2 may contain zeros. In practice this may be dealt with by taking w0 and w1 a vector containing real numbers. After additions the sign of the result is taken, and the resulting watermark is embedded.

In another embodiment of the invention, an image of the image signal may be divided in three or more areas, where in at least two areas, watermark samples are embedded in an de-flickering robust way, whereas in at least a third area, only one version of each watermark sample is embedded. For example, a reference watermark is embedded in a first area, whereas a shifted watermark is embedded in the second and in the third area. In this way, even if the reference watermark is removed by a de-flickering tool, the payload may still be extracted by means of a time-synchronization with the original movie.

The invention can be implemented in any suitable form including hardware, software, firmware or any combination of these. The invention or some features of the invention can be implemented as computer software running on one or more data processors and/or digital signal processors. The elements and components of an embodiment of the invention may be physically, functionally and logically implemented in any suitable way. Indeed, the functionality may be implemented in a single unit, in a plurality of units or as part of other functional units. As such, the invention may be implemented in a single unit, or may be physically and functionally distributed between different units and processors.

Although the present invention has been described in connection with the specified embodiments, it is not intended to be limited to the specific form set forth herein. Rather, the scope of the present invention is limited only by the accompanying claims. In the claims, the term “comprising” does not exclude the presence of other elements or steps. Additionally, although individual features may be included in different claims, these may possibly be advantageously combined, and the inclusion in different claims does not imply that a combination of features is not feasible and/or advantageous. In addition, singular references do not exclude a plurality. Thus, references to “a”, “an”, “first”, “second” etc. do not preclude a plurality. Furthermore, reference signs in the claims shall not be construed as limiting the scope.

1. Method of embedding a payload in a motion image signal, the method comprising:
representing a first and a second watermark by a first sequence of watermark samples;
determining a first and a second global property of an image of the signal, the second global property being different from the first global property;
embedding the first and the second watermark in the signal, so that a shift of the second watermark with respect to the first watermark represents a payload;
wherein the first and the second watermarks are embedded by modifying the first and the second global property in the image in accordance with the corresponding watermark samples.

2. Method according to claim 1, wherein the first global property is a first color component of the image signal, and the second global property is a second color component of the image signal.

3. Method according to claim 1, wherein the first global property is the mean luminance of the pixels constituting the image, and the second global property is the mean color saturation of the pixels constituting the image.

4. Method according to claim 1, wherein an image of the image signal is divided into two image areas, the first and the second watermark being embedded in an image area of the image by modifying the first and the second global properties of the image area.

5. Method according to claim 1, wherein each watermark sample of the first sequence of watermark samples being a first or a second value.

6. Method according to claim 4, wherein modifying includes adaptively modifying the pixels of the image or image area upon a spatial activity within the image or image area.

7. Method according to claim 4, wherein modifying includes adaptively modifying the pixels of the image or image area upon motion detected between consecutive images or image areas.

8. Method according to claim 1, wherein a watermark sample of the first and the second watermark are embedded in a series of consecutive images.

9. Method according to claim 5, further comprising:
dividing an image of the image signal into at least two image areas,
determining a first global property of an image area, and a second global property of the first and second image area;
embedding the first watermark by modifying the first global property in at least one image area of the image; and
embedding the second watermark by modifying the image to increase the second global property of the first area and decrease the at least second global property of the at least second area for embedding the first value of the watermark sample into the image, and to decrease the at least second global property of the first area and increase the at least second global property of the at least second area for embedding the at least second value of the watermark sample into the image.

10. Method according to claim 5, further comprising:
dividing an image of the image signal into at least four image areas, in a first and in a second area the first watermark is embedded, and in a third and a fourth area the at least second watermark is embedded,
determining a first global property of the first and second image areas, and at least a second global property of the third and fourth image areas;
modifying the image to increase the first global property of the first area and decrease the first global property of the second area for embedding the first value of the watermark sample into the image, and to decrease the first global property of the first area and increase the first global property of the second area for embedding the at least second value of the watermark sample into the image; and
modifying the image to increase the at least second global property of the third area and decrease the at least second global property of the at least fourth area for embedding the first value of the watermark sample into the image, and to decrease the at least second global property of the third area and increase the at least second global property of the at least fourth area for embedding the at least second value of the watermark sample into the image.

11. Method of extracting a payload from a motion image signal, the method comprising:
receiving an image signal including a first watermark and at least a second watermark, the first and the at least second watermarks being representing by at least a first sequence of watermark samples;
providing the first and at least second watermarks to be detected in the image signal;
determining a first and at least a second global property of an image of the signal in the signal;
extracting the first watermark by comparing a sequence of first global properties with the first watermark to be detected;
extracting the at least second watermark by comparing a sequence of at least second global properties with the at least second watermark to be detected;
comparing the first and the at least second watermark so as to determine a shift of the at least second watermark with respect to the first watermark;
extracting from the shift a payload.

12. Watermark embedder comprising:
signal unit (1) for receiving a motion image signal;
watermark sample unit (7) for representing a first and an at least second watermark by at least a first sequence of watermark samples;
global property unit (9) for determining a first and at least a second global property of an image of the signal;
embedding unit (2) for embedding the first and the at least second watermark in the signal, so that a shift of the at least second watermark with respect to the first watermark represents a payload;
wherein the first and the at least second watermarks are embedded in the embedding unit by modifying the first and the at least second global property in the image in accordance with the corresponding watermark samples.

13. Watermark detector comprising:
signal unit (30) for receiving a motion image signal, the image signal including a first watermark and at least a second watermark, the first and the at least second watermarks being representing by at least a first sequence of watermark samples;
watermark unit (36) for providing the first and at least second watermarks to be detected in the image signal;
global property unit (40) for determining a first and at least a at least second global property of an image of the signal;
extractor unit (34) for extracting the first watermark by comparing a sequence of first global properties with the first watermark to be detected, and for extracting the at least second watermark by comparing a sequence of at least second global properties with the at least second watermark to be detected;
comparator unit (35) for comparing the first and the at least second watermark so as to determined a shift of the at least second watermark with respect to the first watermark;
payload unit (39) for extracting from the shift a payload.

14. (canceled)

15. (canceled)

16. (canceled)

17. (canceled)
